(19) United States
(12) Patent Application Publication
(10) Pub. No.: US 2026/0044871 A1
(43) Pub. Date: Feb. 12, 2026

(54) METHODS FOR GENERATING DATA INSIGHTS USING AI AND NATURAL LANGUAGE PROCESSING

(71) Applicant: Jones Lang LaSalle IP, Inc., Chicago, IL (US)

(72) Inventors: Sidney JOSEPH, Chicago, IL (US); Sahil SHARMA, Bathinda (IN); Warda LAKNAOUI, Mesa, AZ (US); Jan CISLINSKY, Stochov (CZ); Sridhar KONDOJI, Allen, TX (US)

(21) Appl. No.: 18/796,205

(22) Filed: Aug. 6, 2024

(51) Int. Cl. G06Q 30/0203

(52) U.S. Cl. CPC G06Q 30/0203

(57) ABSTRACT

A method, system, and non-transitory computer readable medium includes receiving a response to a survey from a client device, where the survey is transmitted to the client device and the response is received via a link. The method then generates insight data by analyzing marketing data through a machine learning model. This marketing data is produced using a natural language processor that examines a prompt derived from the survey response. Finally, the method includes providing a graphical user interface on the client device that displays the generated insight data.

### FIELD

This technology generally relates to generating DATA insights and, more particularly, to methods for generating insights using artificial intelligence and natural language processing and devices thereof.

### BACKGROUND

In commercial real estate, current methods for collecting marketing data from brokers across multiple accounts that can be used for portfolio and real estate planning are duplicative and time consuming. For example, most users rely on using email threads across each account to collect data from brokers, which results in asking brokers for repetitive information. Additionally, any collected data requires review and analyzation to generate useful insights. By way of example, brokers require in real time the generation of: i) portfolio strategies, ii) real estate and financial services plans, and iii) real estate transactions workflow processes. However, currently no effective mechanism for generating such strategies, summaries, or documentation exists.

### SUMMARY

A method that generates insights using artificial intelligence and natural language processing includes receiving a response to a survey from a client device, where the survey is transmitted to the client device and the response is received via a link. The method then generates insight data by analyzing marketing data through a machine learning model. This marketing data is produced using a natural language processor that examines a prompt derived from the survey response. Finally, the method includes providing a graphical user interface on the client device that displays the generated insight data.

A non-transitory computer readable medium having stored thereon instructions comprising machine executable code which when executed by at least one processor, causes the processor to receive a response to a survey from a client device, where the survey is transmitted to the client device and the response is received via a link. The executable code which when executed by at least one processor, causes the processor to then generates insight data by analyzing marketing data through a machine learning model. This marketing data is produced using a natural language processor that examines a prompt derived from the survey response. Finally, the executable code which when executed by at least one processor, causes the processor to provide a graphical user interface on the client device that displays the generated insight data.

A computing apparatus including at least one of configurable hardware logic configured to be capable of implementing or a processor coupled to a memory and configured to execute programmed instructions stored in the memory to receive a response to a survey from a client device, where the survey is transmitted to the client device and the response is received via a link. The executable code which when executed by at least one processor, causes the processor to then generates insight data by analyzing marketing data through a machine learning model. This marketing data is produced using a natural language processor that examines a prompt derived from the survey response. Finally, the executable code which when executed by at least one processor, causes the processor to provide a graphical user interface on the client device that displays the generated insight data.

This technology provides a number of advantages including providing a method, non-transitory computer readable medium, and apparatus that enable the generation of data insights, documents, and summaries. This technology is able to eliminate redundancies, ease analysis, effectively generate documents, and accurately predict analytics. Examples of this technology enable the generation of portfolio strategies based on collected and unified market data from brokers. Examples of the claimed technology also are able to generate real estate and financial services plans on a site level based on generated scenarios and can optimize real estate transactions workflow processes by dynamically generating real estate and financial services documents. This claimed technology can provide a hierarchical graphical user interface panel to efficiently correlate a user's portfolio with market data to generate the scenarios, workflow processes, and strategies. This type of technology can enable the generation of data insights, summaries, and documents, for example in the real estate and financial services area, in real time with accurate, customized data which has not previously been available.

### BRIEF DESCRIPTION OF THE DRAWINGS

FIG. 1 is a block diagram of an example of an environment with a marketing computing system configured to generate real estate and financial services insights, plans, and transactions workflow processes;

FIG. 2A is a block diagram illustrating an example of an architecture of a marketing computing system;

FIG. 2B is a block diagram illustrating an example of an architecture of a database;

FIG. 2C is a block diagram illustrating an example of an architecture of a client device;

FIG. 3 is an exemplary flowchart of an exemplary method of generating real estate and financial services insights;

FIG. 4 is an exemplary interface of a portfolio generated by the marketing computing system;

FIG. 5 is an exemplary interactive interface for the marketing computing system to receive input from a client device;

FIG. 6 is an exemplary interface with a dialog window allowing a selection of a new scenario to generate real estate and financial services insights, plans, and transactions workflow processes;

FIG. 7 is an exemplary interface with an available selection of real estate insight options;

FIG. 8 is an exemplary interface with an available selection of real estate insight options;

FIG. 9 is an exemplary interface with a selected real estate insight option;

FIG. 10 is an exemplary interface allowing a client device to generate documents or a summary using the marketing computing system;

FIG. 11 is an exemplary interface allowing a client device to generate documents using the marketing computing system; and

FIG. 12 is an exemplary interface illustrating generated scenarios from the marketing computing system.

### DETAILED DESCRIPTION

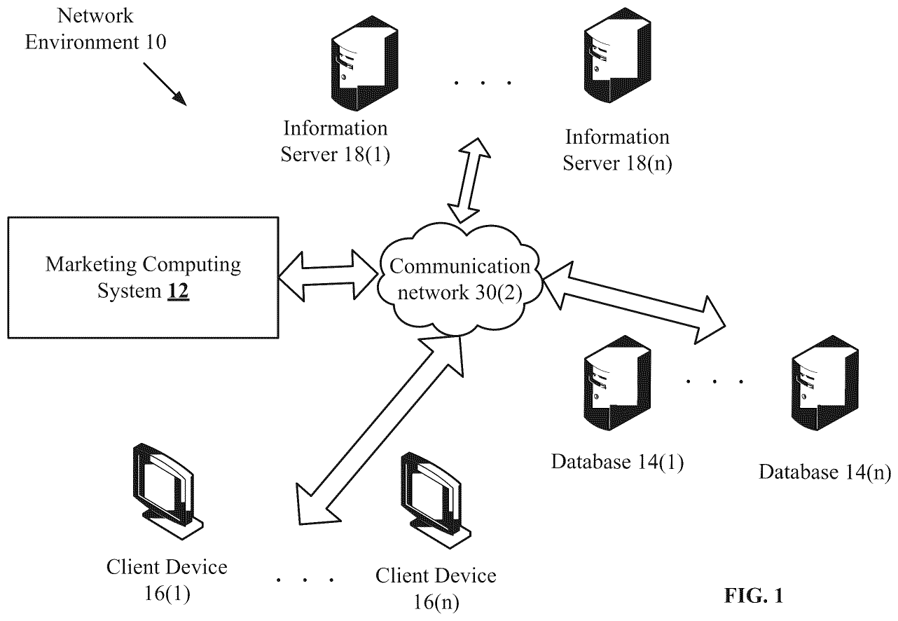

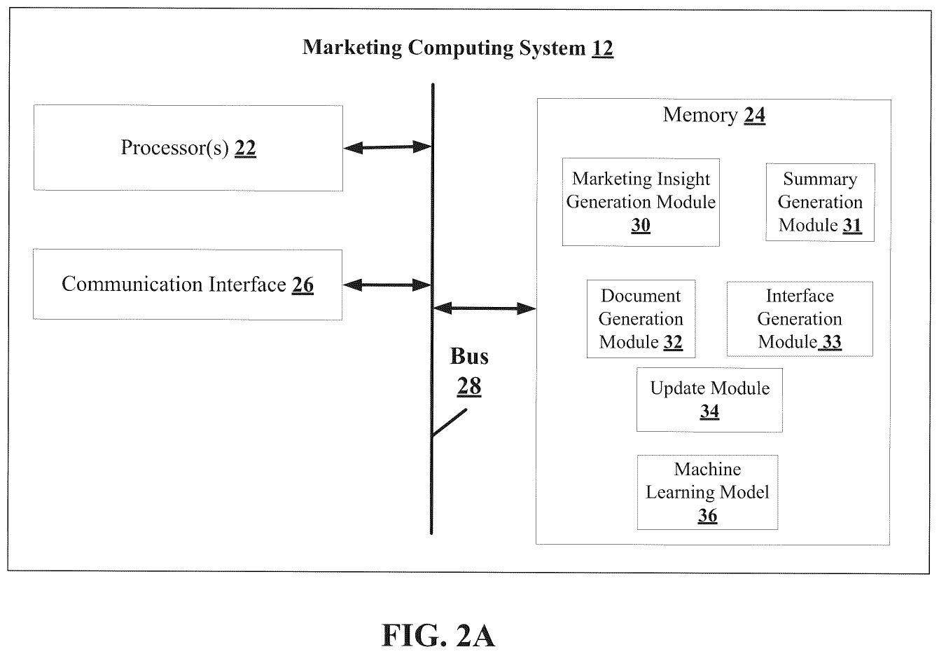

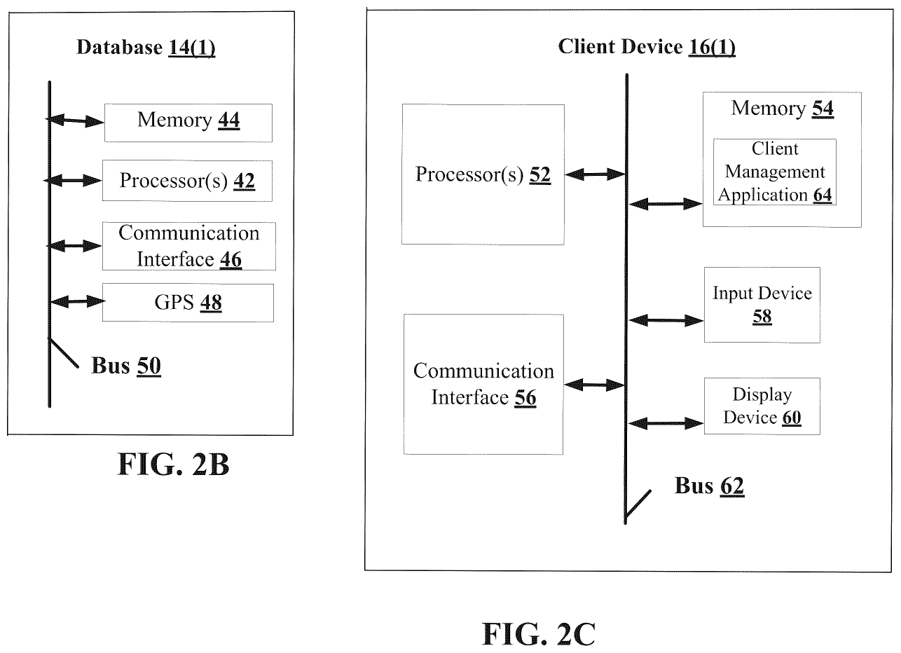

An environment 10 with an exemplary marketing computing system 12 is shown in FIGS. 1-2C. In this example, the environment 10 includes the marketing computing system 12, a plurality of databases 14(1)-14(n), a plurality of client devices 16(1)-16(n), and a plurality of information servers 18(1)-18(n), although the environment may comprise other types and/or numbers of other systems, devices, components, and/or other elements in other configurations. This technology provides a number of advantages including providing systems, methods, and non-transitory computer readable media that enable the generation of data insights, documents, and summaries, for example in the real estate and financial services area. This technology is able to eliminate redundancies, ease analysis, effectively generate documents, and accurately predict analytics.

Referring to more specifically to FIGS. 1-2A, in this example, the marketing computing system 12 includes one or more processor(s) 22, a memory 24, and/or a communication interface 26, which are coupled together by a bus or other communication link 28, although the marketing computing system 12 can include other types and/or numbers of elements in other configurations.

The processor(s) 22 of the marketing computing system 12 may execute programmed instructions stored in the memory of the marketing computing system 12 for any number of functions and other operations as illustrated and described by way of the examples herein. The processor(s) 22 of the marketing computing system 12 may include one or more CPUs or general purpose processors with one or more processing cores, for example, although other types of processor(s) can also be used.

The memory 24 of the marketing computing system 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 24.

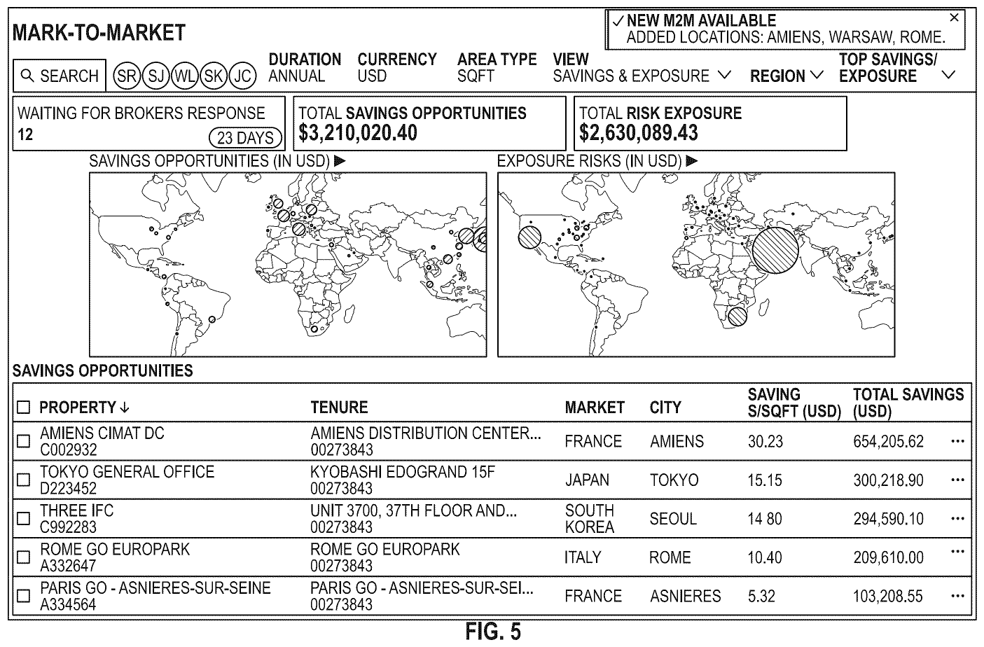

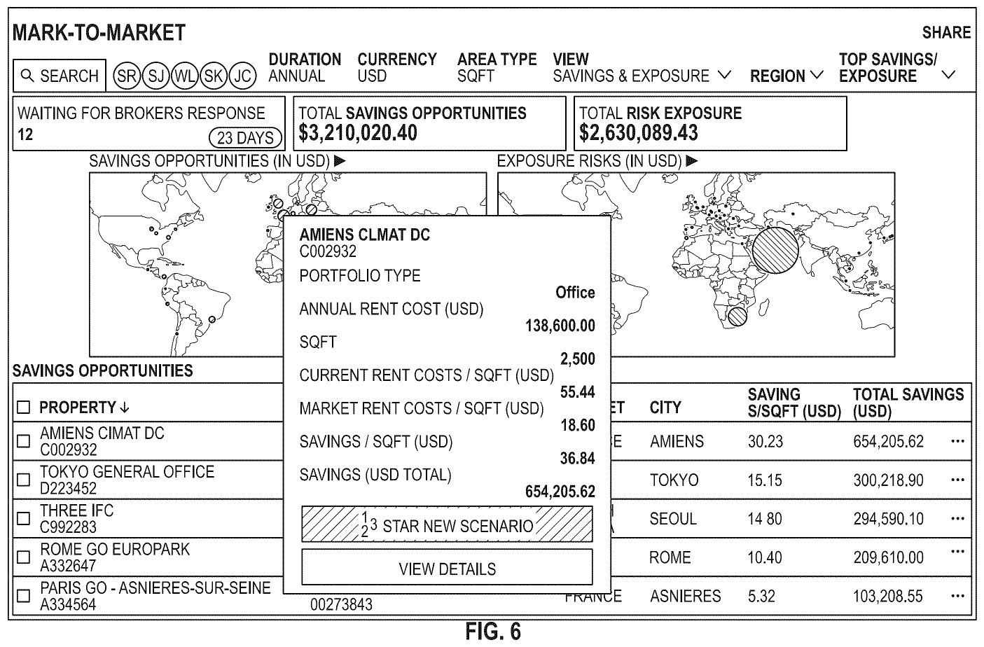

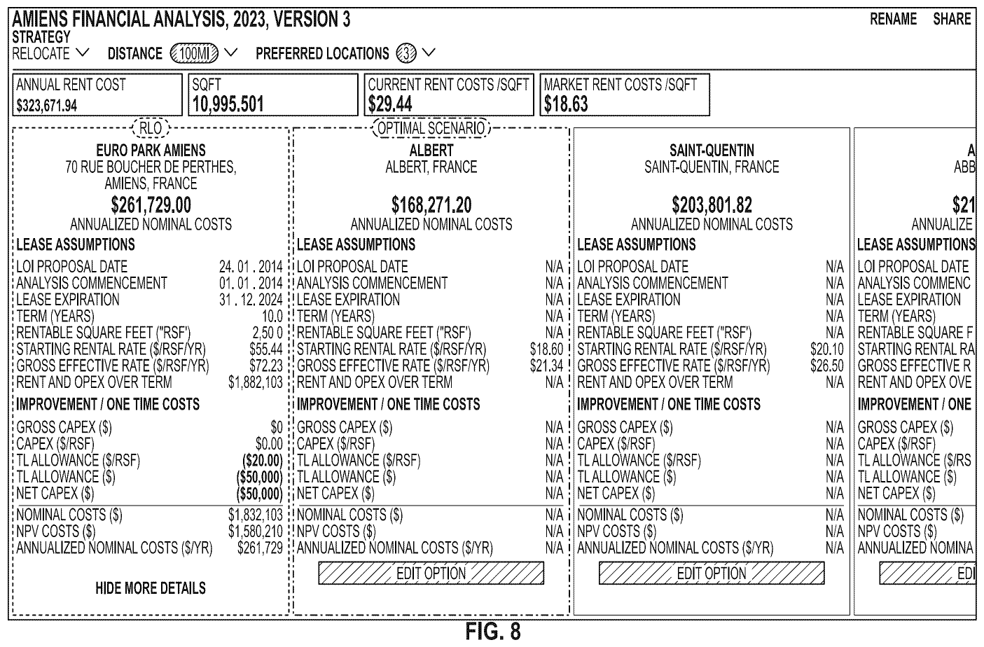

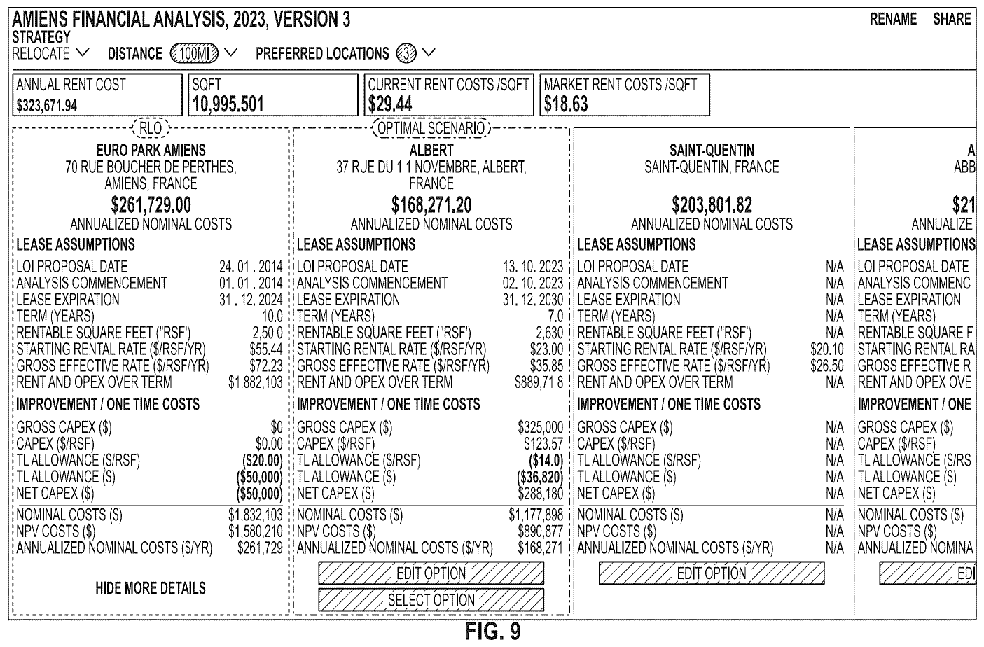

Accordingly, the memory 24 of the marketing computing system 12 can store one or more applications that can include computer executable instructions that, when executed by the marketing computing system 12, cause the marketing computing system 12 to perform actions, such as to generate real estate and financial services insights from data stored in one or more databases 14(1)-14(n) with one or more client devices 16(1)-16(n) and one or more information servers 18(1)-18(n) in the environment 10, and other actions as described and illustrated in the examples below with reference to FIG. 1-12. The application(s) can be implemented as modules, programmed instructions, or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the marketing computing system 12 itself, may be located in virtual server(s) running in a cloud-based computing environment rather than being tied to one or more specific physical computing devices. Also, the application(s) may be running in one or more virtual machines (VMs) executing on the marketing computing system 12. Additionally, in one or more embodiments of this technology, virtual machine(s) running on the marketing computing system 12 may be managed or supervised by a hypervisor.

In this particular example, the memory 24 of the marketing computing system 12 may include a marketing insight generation module 30, a summary generation module 31, a document generation module 32, an interface generation module 33, an update module 34, and a machine learning model (MLM) 36 which may be executed as illustrated and described by way of the examples herein, although the memory 24 can for example include other types and/or numbers of modules, platforms, algorithms, programmed instructions, applications, or databases for implementing examples of this technology. In some embodiments, the marketing insight generation module 30, the summary generation module 31, the document generation module 32, the interface generation module 33, the update module 34, and/or the MLM 36 can be one unified module that performs the functions of the marketing insight generation module 30, the summary generation module 31, the document generation module 32, the interface generation module 33, the update module 34, and/or the MLM 36.

The marketing insights generation module 30 may comprise executable instructions that are configured to interact with any of the client devices 16(1)-16(n) to create and collect marketing data for any of the databases 14(1)-14(n) for the generation of real estate and financial services insights. The marketing intel generation module 30 may also comprise executable instructions that are configured to execute other operations and/or functions as illustrated and described in greater detail by way of the examples herein, although this module may have executable instructions that are configured to execute other types and/or functions or other operations to facilitate examples of this technology, such as injecting data from interactions with any of the client devices 16(1)-16(n) into the MLM 36 for the generation of real estate and financial services insights, by way of example.

The summary generation module 31 may comprise executable instructions that are configured to interact with any of the client devices 16(1)-16(n) to create and collect marketing data for any of the databases 14(1)-14(n) for the generation of real estate and financial services scenarios or summaries. The summary generation module 31 may also comprise executable instructions that are configured to execute other operations and/or functions as illustrated and described in greater detail by way of the examples herein, although this module may have executable instructions that are configured to execute other types and/or functions or other operations to facilitate examples of this technology, such as using the MLM 36 for the generation of real estate and financial services scenarios or summaries, by way of example.

The document generation module 32 may comprise executable instructions that are configured to interact with any of the client devices 16(1)-16(n) to create and collect marketing data for any of the databases 14(1)-14(n) for the generation of real estate and financial services documents. The document generation module 32 may also comprise executable instructions that are configured to execute other operations and/or functions as illustrated and described in greater detail by way of the examples herein, although this module may have executable instructions that are configured to execute other types and/or functions or other operations to facilitate examples of this technology, such as injecting data from interactions with any of the client devices 16(1)-16(n) into the natural language processor 35, then extracted data from the natural language processor 35 into the MLM 36 for the generation of real estate and financial services documents, by way of example.

The interface generation module 33 may comprise executable instructions that are configured to generate a graphical user including a plurality of graphical user interfaces using the marketing data, insight data, predictive data, document data, or output from the natural language processor 35 or MLM 36, as illustrated and described in greater detail by way of the examples herein, although this module may have executable instructions that are configured to execute other types and/or functions or other operations to facilitate examples of this technology, such as transmitting the graphical user interface to one of the client devices 16(1)-16(n) by way of example.

The update module 34 may comprise executable instructions that are configured to update marketing data, insight data, predictive data, document data, data, or combinations thereof stored in the databases 14(1)-14(n) as illustrated and described in greater detail by way of the examples herein, although this module may have executable instructions that are configured to execute other types and/or functions or other operations to facilitate examples of this technology.

The MLM 36 may be one or more machine learning models 36. In one example, one of the MLMs 36 may be a natural language processor or a large language model. In this example, one or more developers may fine-tune a pre-trained LLM with marketing data to generate a fine-tuned LLM for specific use cases. Although not illustrated, the plurality of information servers 18(1)-18(n) may host and/or manage a plurality of LLMs which may be pre-trained general purpose LLMs or fine-tuned LLMs. The plurality of information servers 18(1)-18(n) may be a cloud-based server or an on-premises server. The fine-tuned LLMs may be accessed using an application programming interface (API) for use in applications. In another example, the fine-tuned LLM may be hosted by the plurality of information servers 18(1)-18(n) and managed remotely by the marketing computing system 12.

The MLM 36 can also be a natural language processor or a type of artificial intelligence-machine learning (AI/ML) model that is used to process natural language data for tasks such as natural language processing, text mining, text classification, machine translation, question-answering, response generation, or the like. The MLM 36 uses deep learning or neural networks to learn language features from large amounts of data. The MLM 36 is, for example, trained on a large dataset and then used to generate predictions or generate features from unseen data. The MLM 36 can be used to generate language features such as word embeddings, part-of-speech tags, named entity recognition, sentiment analysis, or the like. Unlike traditional rule-based NLP systems, the MLM 36 does not have to rely on pre-defined rules or templates to generate responses. Instead, the MLM 36 can use a probabilistic approach to language generation, where the MLM 36 can calculate the probability of each word in a response based on the patterns the MLM 36 learned from the training data.

The marketing computing system 12 may contain programs that train, implement, store, receive, retrieve, and/or transmit one or more MLMs 36. MLMs 36 may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The marketing computing system 12 may be configured to adjust model parameters during training. Model parameters may include weights, coefficients, offsets, or the like. Training may be supervised or unsupervised.

The marketing computing system 12 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The marketing computing system 12 may be configured to optimize statistical models using known optimization techniques.

The marketing computing system 12 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The marketing computing system 12 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some examples, the marketing computing system 12 is configured to generate and/or train the MLM 36 to classify a dataset, consistent with disclosed examples.

The communication interface 26 of the marketing computing system 12 operatively couples and communicates between the marketing computing system 12 and the one or more of databases 14(1)-14(n), the one or more of the client devices 16(1)-16(n), and the one or more information servers 18(1)-18(n), although other types and/or numbers of connections and/or communication networks can be used.

While the marketing computing system 12 is illustrated in this example as including a single device, the marketing computing system 12 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the marketing computing system 12.

Additionally, one or more of the devices that together comprise the marketing computing system 12 in other examples can be standalone devices or integrated with one or more other devices or apparatuses, such as in one of the server devices or in one or more computing devices for example. Moreover, one or more of the devices of the marketing computing system 12 in these examples can be in a same or a different communication network including one or more public, private, or cloud networks, for example.

Although an exemplary marketing computing system 12 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in this marketing computing system 12, such as the marketing computing system 12, for example, may be configured to operate as virtual instances on the same physical machine. In other words, by way of example one or more of the marketing computing system 12 may operate on the same physical device rather than as separate devices communicating through communication network(s). Additionally, there may be more or fewer marketing computing system 12 than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to conduct steps necessary to implement the methods of the examples of this technology that are described and illustrated herein.

Referring to FIGS. 1 and 2B, the plurality of databases 14(1)-14(n) may comprise a variety of different types and/or numbers of systems, devices, or other things in the environment 10, such as a variety of different marketing data, insight data, predictive data, document data, data, or combinations thereof by way of example only. In this example, the marketing computing system 12 has a table, a data structure, or other manner organizing the marketing data, insight data, predictive data, document data, data, or combinations thereof by way of example, although other manners for categorizing and organizing the data can be used. In this example, each of the databases 14(1)-14(n) at least have the same following structure and operation as shown in the example of the database 14(1) shown in FIG. 2B, although databases 14(1)-14(n) with other types and/or numbers of other systems, devices, components, and/or other elements may be used. Additionally, in this example, the database 14(1) has one or more processors 42, a memory 44, a communication interface, and a global positioning system (GPS) device 48 which are coupled together by a bus or other communication link 50, although each database of data could have other types and/or numbers of systems, devices, components and/or other elements in other configurations.

Referring to FIGS. 1 and 2C, the plurality of client devices 16(1)-16(n) in this example includes any type of computing device that can participate in the generation of real estate and financial services insights, plans, and transactions workflow processes using data structures, marketing data, insight data, predictive data, document data, and data in an environment 10 with a client management application 64, such as mobile computing devices, desktop computing devices, laptop computing devices, tablet computing devices, virtual machines (including cloud-based computers), or the like. In this example, each of the client devices 16(1)-16(n) at least have the same following structure and operation as shown in the example of the client device 16(1) shown in FIG. 2C, although client devices with other types and/or numbers of other systems, devices, components, and/or other elements may be used. Additionally in this example, the client device 16(1) includes one or more processor 52, a memory 54, a communication interface 56, an input device 58, and a display device 60, which are coupled together by a bus or other communication link 62, types and/or numbers of systems, devices, components, or other elements in other configurations. Additionally, in this example the memory 54 includes a client management application 64 which enables the client 16(1) to interact with the marketing computing system 12 and one or more of the databases 14(1)-14(n) as illustrated and described by way of the examples herein, although the memory 54 can include other programmed instructions, modules, applications, or other data for example.

The plurality of information servers 18(1)-18(n) in this example includes one or more processors, a memory, and a communication interface, which are coupled together by a bus or other communication link, although other numbers and/or types of network devices could be used. In this example, the information servers 18(1)-18(n) can be located at different locations and may each process requests received from the marketing computing system 12 and/or the client devices 16(1)-16(n) via the communication network(s) 20. Various data and other applications may be operating on the marketing computing system 12 and transmitting data (e.g., files or Web pages) to the marketing computing system 12 and/or the client devices 16(1)-16(n). The information servers 18(1)-18(n) may be hardware or software or may represent a system with multiple servers in a pool, which may include internal or external networks.

An exemplary method for generating real estate and financial services insights using machine learning models 36 in the environment 10 with the marketing computing system 12 and one or more of the client devices 16(1)-16(n) will now be described with reference to FIG. 1-12.

### Generating a Centralized Repository

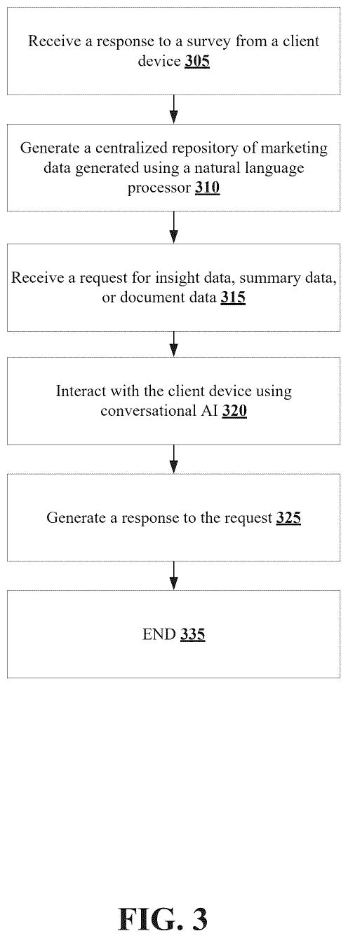

Referring more specifically to FIG. 3, in step 305, the marketing computing system 12 receives a response to a survey from a client device at one of the client devices 16(1)-16(n). The survey can comprise inquiries related to a market, a transaction, or real estate client preferences. The marketing computing system 12 can transmit the survey via a link to the client device at one of the client devices 16(1)-16(n) prior to receiving the response to the survey. The client device at one of the client devices 16(1)-16(n), can receive the link through various communication channels, such as email, SMS, phone application, web notification, and other ways known in the art. Once the link is received, the client device at one of the client devices 16(1)-16(n) can click on the link, which can direct the client device at one of the client devices 16(1)-16(n) to a web-based survey platform. The survey platform can be hosted on a server at one of the information servers 18(1)-18(n) that can be configured to process the survey responses. The client device at one of the client devices 16(1)-16(n) can complete the survey by answering the questions presented and submit the responses to the questions through the survey platform. The marketing computing system 12 can then receive the response from the client device at one of the client devices 16(1)-16(n) via the link.

To begin building a centralized repository, in step 310, the marketing computing system 12 can generate a centralized repository by generating the marketing data for the centralized repository using a natural language processor. The natural language processor can be one of one or more MLMs 36. The natural language processor can be configured to process natural language data for tasks such as natural language processing, text mining, text classification, machine translation, question-answering, response generation, or the like. The natural language processor can use deep learning or neural networks to learn language features from large amounts of data. The natural language processor can be trained on a large dataset and then used to generate predictions or generate features from unseen data. The natural language processor can be configured to analyze prompts comprising instructions to generate marketing data.

In this example, the marketing computing system 12 can analyze the response by parsing the response for textual data. The marketing computing system 12 can then generate a prompt based on the textual data. The prompt can comprise instructions comprising a concatenation of strings. The marketing computing system 12 can generate the concatenation of strings using the textual data. The instructions can include a predefined base string that are basic instructions for the natural language processor to generate the marketing data. The marketing computing system 12 can transmit an API call to the natural language processor with the prompt as a parameter.

The natural language processor can be configured to generate the marketing data using the prompt as the parameter. The predefined base string can signal the natural language processor to process the textual data in the prompt and to generate the marketing data by: tokenizing the textual data in the prompt and identifying key elements and sentiments within the textual data. The natural language processor can be trained to identify key elements and sentiments in responses using a large dataset of historical responses and pre-generated responses. The natural language processor can then generate the marketing data using the identified key elements and sentiments. The marketing computing system 12 can then receive a response from the natural language processor with the marketing data. The marketing computing system 12 can store the marketing data in the centralized repository at one of the databases 14(1)-14(n).

### Processing Requests Using Conversational AI

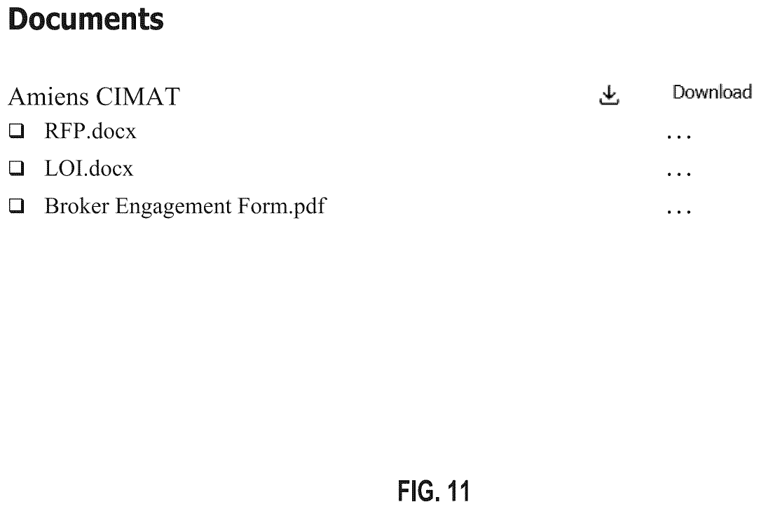

The marketing computing system 12 can receive a login request from the client device at one of the client devices 12(1)-12(n). Then, the marketing computing system 12 can authenticate the client device at one of the client devices 12(1)-12(n) based on login data in the login request. In step 315, the marketing computing system 12 can receive a request for insight data, summary data, or document data from the client device at one of the client devices 12(1)-12(n). The insight data can be recommended campaigns, marketing strategies generated using adversarial networks, or time series forecasting of properties. The summary data can be an executive summary, closing statements, appraisal summaries, property condition reports, or other summaries known in the art. The document data can include purchase agreements, property deeds, mortgage documents, title insurance policies, inspection reports, disclosure statements, or other documents known in the art (as illustrated in FIG. 11).

### Conversational AI

In step 320, the marketing computing system 12 can interact with the client device at one of the client devices 12(1)-12(n) using conversational AI. The conversational AI can be one of the one or more MLMs 36. The marketing computing system 12 can generate a graphical user interface (GUI) comprising a dialog window configured to transmit responses and receive user queries. The marketing computing system 12 can engage in a dynamic, real-time dialogue with the client device at one of the client devices 12(1)-12(n) using the conversational AI to gather conversation data for completing the request.

### Clusters

In step 325, the marketing computing system 12 can generate a response to the request for insight data, summary data, or document data from the client device at one of the client devices 12(1)-12(n) by generating a cluster of the marketing data. The MLM 36 can be configured to preprocess the marketing data and apply clustering algorithms to analyze patterns and trends within the marketing data. The clustering algorithms can segment the marketing data into data points and group the data points into clusters based on levels of similarities between the data points. The marketing computing system 12 can then assign each data point to a cluster center forming clusters of vectors based on a distance metric. Each cluster in the resulting clusters of data points will include similar data points.

### Insight Data

The marketing computing system 12 generates insight data based on marketing data using one of the one or more MLMs 36. The MLM 36 can be trained and configured to: i) identify patterns and customer behaviors and preferences, or ii) generate predictions, based on the clusters of data points.

In one example, when the request is for insight data, such as a marketing campaign, the MLM 36 can be configured to recommend marketing campaigns or strategies likely to resonate with a group of customers by identifying clusters related to a desired marketing campaign. The MLM 36 can be configured to identify patterns and tends such as customer preferences, purchasing behaviors, and demographic information using the clusters of the marketing data. The MLM 36 can be configured to then segment the clusters into groups based on identified patterns. Then, the MLM 36 can be configured to use predictive analytics to forecast potential successful marketing strategies for each segment based on the clusters in each respective segment. The MLM 36 can then be configured to generate a tailored marketing campaign with recommended specific content, channels, engagement, and conversion rates for each segment. The request may include a target segment, and the marketing computing system 12 can use the MLM 36 to generate the tailored marketing campaign for the target segment.

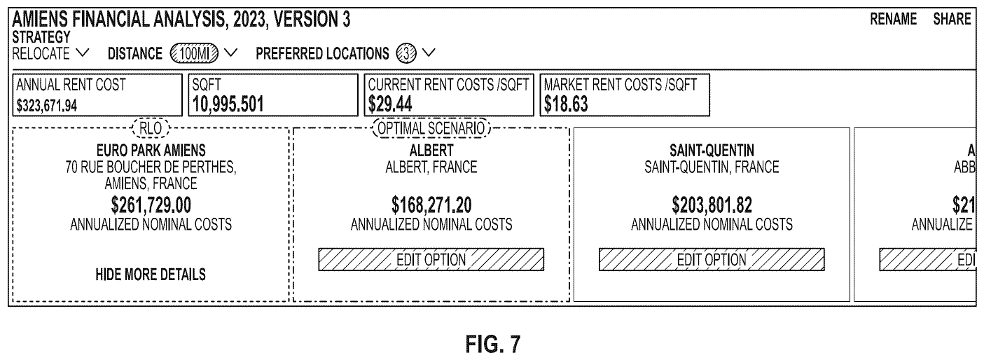

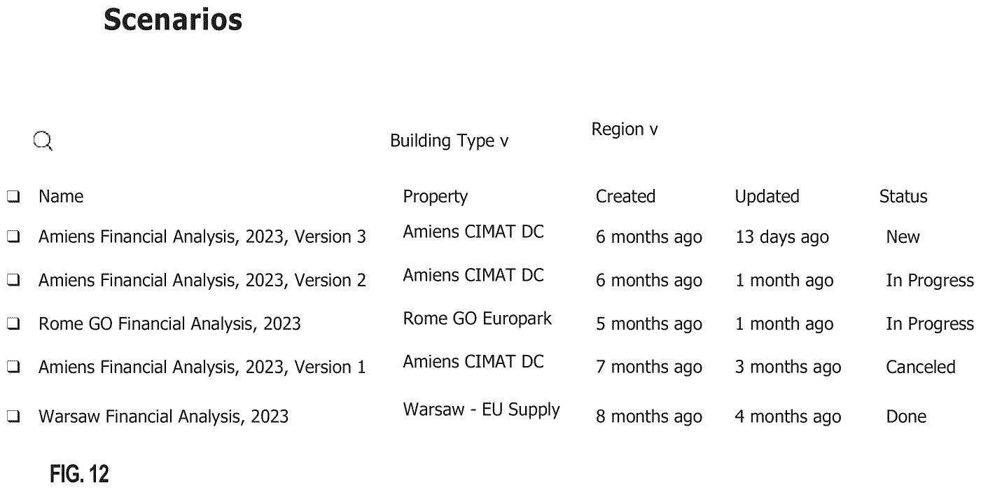

In another example, the MLM 36 can also be configured to generate adversarial networks by simulating potential market scenarios (such as the scenarios illustrated in FIG. 12) using the clusters. The MLM 36 can also be configured to generate adversarial networks based on marketing data by first training a generator network to create synthetic marketing scenarios that mimic real data. Concurrently, a discriminator network can be trained to distinguish between real marketing data and the synthetic scenarios produced by the generator network. Through iterative training, the generator network can improve the ability to produce realistic scenarios, while the discriminator network becomes more adept at identifying realistic scenarios. The MLM 36 can be trained using this process until the generator network produces highly realistic marketing scenarios, which can be used by the marketing computing system 12 to test and optimize marketing strategies. The marketing computing system 12 can use the optimized marketing strategies as insight data. The marketing computing system 12 can modify the GUI to include marketing strategies related to properties as illustrated in FIG. 7. The modified GUI can be interactive allow the client device at one of the client devices 16(1)-16(n) to receive insight data in real-time as illustrated in FIG. 7-9.

In another example, the MLM 36 can also be configured to generate time series forecasting of properties by first collecting and pre-processing historical marketing data and the stored market data for information, such as property prices, sales volumes, and market trends. The MLM 36 can then be trained using the historical marketing data and the marketing data and learn the temporal dependencies and trends through algorithms such as ARIMA, LSTM, Prophet, or other algorithms known in the art. The MLM 36, once trained, can be configured to predict future property values and market conditions, providing valuable forecasts that inform investment decisions and marketing strategies. The MLM 36 can also dynamically learn the goals of the client device at one of the client devices 16(1)-16(n) to optimize a portfolio of the client device 16 or the predictive insight data (market strategies, marketing campaigns, etc.) as illustrated in FIG. 12.

The marketing computing system 12 can then provide a modified GUI comprising the insight data to the client device at one of the client devices 16(1)-16(n), and the process can terminate at step 330.

### Summary Data

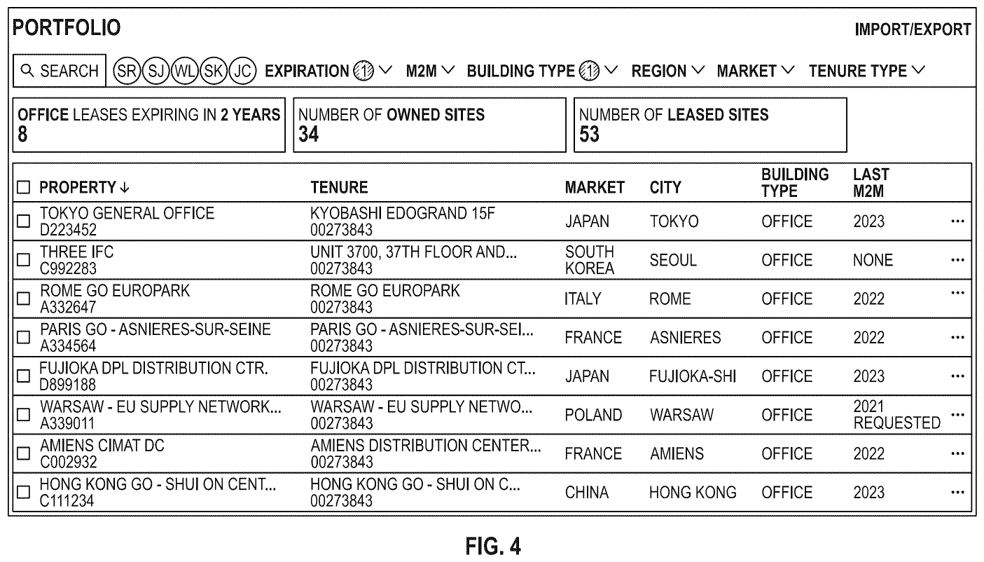

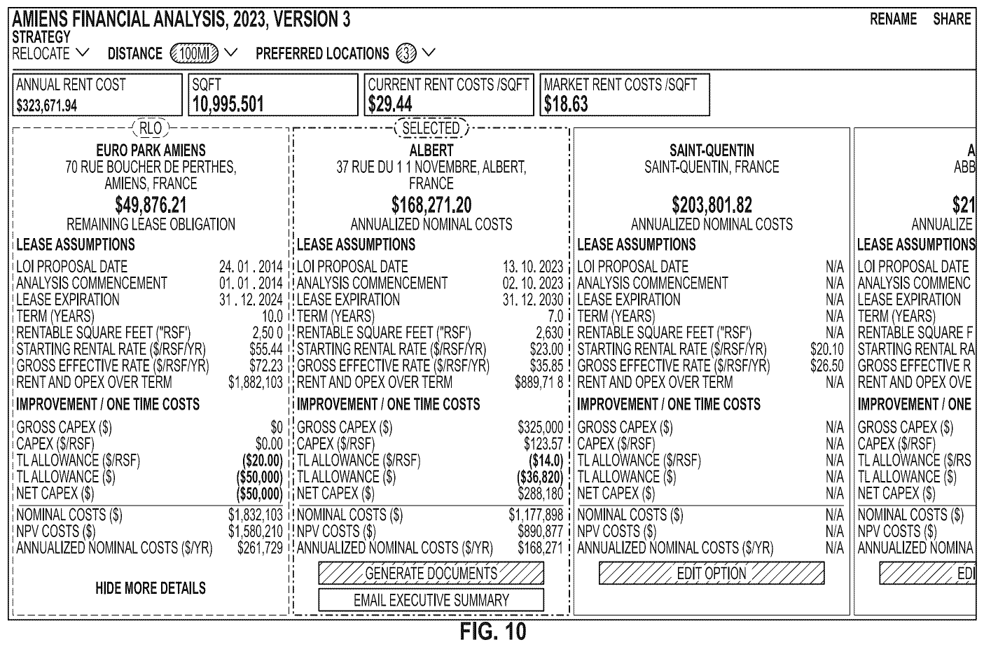

When engaging with the client device at one of the client devices 16(1)-16(n) with the conversational AI, the marketing computing system 12 can use the conversational AI to guide the dialogue to extract inputs needed to generate an executive summary. The executive summary can comprise of client goals to optimize a portfolio of a client at the client device at one of the client devices 16(1)-16(n) (the GUI can include the portfolio of the client, a list of opportunities, or a map of markets to allow the client to select a property or transaction for the input of the executive summary as illustrated in FIG. 4-6). The MLM 36 can also dynamically learn the goals of the client device at one of the client devices 16(1)-16(n) to optimize a portfolio of the client device 16. The MLM 36 can also be configured to generate the executive summary by parsing through the clusters for information relating to a requested property. The MLM 36 can then be trained to collect related property data from the clusters (or retrieve the related property data from the centralized repository at one of the databases 14(1)-14(n)) and compare accounts and properties in the marketing data including leases and options relating to the requested property. The MLM 36, once trained, can be configured to generate the executive summary using the collected related property data and the comparisons of the accounts and properties. The executive summary would provide valuable information that can assist a client with investment decisions, goals, and marketing strategies as illustrated in FIG. 10.

In some examples, the MLM 36 can be a large language model. The marketing computing system 12 can generate a prompt (as described above using instructions comprising concatenation of strings using the collected related property data and comparisons) and provide the prompt to the large language model as a parameter through an API call. The large language model can then generate the executive summary as described above. The marketing computing system 12 can then provide a modified GUI comprising the executive summary to the client device at one of the client devices 16(1)-16(n) and the process can terminate at step 330.

### Document Data

When engaging with the client device at one of the client devices 16(1)-16(n) with the conversational AI, the marketing computing system 12 can use the conversational AI to guide the dialogue to extract input data needed to generate a document as illustrated in FIG. 10 (where an interactive GUI allows for a request to generate documents related to a selected property). The document can be a transaction or legal document required for the closing of a transaction or during a real estate process. The marketing computing system 12 can transmit an API call to a server at one of the information servers 18(1)-18(n) for a form or template of a document. The marketing computing system 12 can then receive the form or template from the server at one of the information servers 18(1)-18(n). The marketing computing system 12 can then use the conversational AI to guide the dialogue in real-time to extract the input data needed to fill information in the form or the template. The MLM 36 can also dynamically parsing through the clusters for information relating to the input data of the form or the template to avoid or minimize requesting additional information from the client device at one of the client devices 16(1)-16(n). The MLM 36 can then be trained to collect related data from the clusters (or retrieve the related data from the centralized repository at one of the databases 14(1)-14(n)) and to predict the input data for the form or the template.

In one example, the MLM 36 can be a large language model. The marketing computing system 12 can generate a prompt (as described above using instructions comprising concatenation of strings using the predicted, retrieved, and received input data) and provide the prompt to the large language model as a parameter through an API call to fill the form or template with the input data. The large language model can then generate the document and provide a modified GUI including the document to the client device at one of the client devices 16(1)-16(n).

The marketing computing system 12 can then receive edits for the document from the client device at one of the client devices 16(1)-16(n). The marketing computing system 12 can then modify the document using the edits from the client device at one of the client devices 16(1)-16(n). The marketing computing system 12 can then provide a second modified GUI including the modified document to the client device at one of the client devices 16(1)-16(n). In other examples, the marketing computing system 12, using the conversational AI, can provide each input from the form or template to the client device at one of the client devices 16(1)-16(n) for review and dynamically and in real-time receive edits for each input. The marketing computing system 12 can then modify the document dynamically in real-time while updating and providing the second modified GUI to the client device at one of the client devices 16(1)-16(n). At step 330, the exemplary process terminates.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method comprising:
receiving, by a computing device, a response to a survey from a client device, wherein the survey is transmitted to the client device and the response is received from the client device via a link;
generating, by the computing device, insight data based on marketing data using a machine learning model, wherein the marketing data is generated using a natural language processor by analyzing a prompt based on the response received via the link from the client device; and
providing, by the computing device to the client device, a graphical user interface comprising the insight data.

2. The method as set forth in claim 1, wherein the survey comprises inquiries related to a market, a transaction, or real estate client preferences.

3. The method as set forth in claim 1, further comprises:
storing, by the computing device, the marketing data and the insight data in a centralized repository;
receiving, by the computing device, a query from the client device relating to the marketing data or the insight data in the centralized repository; and
transmitting, by the computing device, a query response to the client device.

4. The method as set forth in claim 3, further comprises:
receiving, by the computing device, a login request from the client device;
authenticating, by the computing device, the client device based on login data in the login request;
receiving, by the computing device, the query related to the marketing data or the insight data; and
generating, by the computing device, the query response using the machine learning model by:
tokenizing the query for key components;
matching the key components to a cluster of vectors; and
generating the query response based on the cluster of vectors.

5. The method as set forth in claim 1, further comprising:
receiving, by the computing device from the client device, an executive summary request and input relating to the executive summary request;
retrieving, by the computing device, related data to the executive summary request or the input from a centralized repository;
transmitting, by the computing device, a prompt comprising the executive summary request, the input, and the related data to a large language model;
receiving, by the computing device, the executive summary from the large language model; and
transmitting, by the computing device, the executive summary to the client device.

6. The method as set forth in claim 1, further comprising:
receiving, by the computing device from the client device, a document request;
modifying and providing, by the computing device, the graphical user interface to the client device, wherein the modified graphical user interface comprises an interactive chat configured to request and receive input from the client device for the document request;
transmitting, by the computing device, a prompt comprising the document request and the input to a large language model;
receiving, by the computing device, a document from the large language model, wherein the document meets requirements of the document request and comprises the input from the client device; and
transmitting, by the computing device, the document to the client device.

7. The method as set forth in claim 6, further comprising:
receiving, by the computing device, edits for the document from the client device;
modifying, by the computing device, the document using the edits from the client device; and
providing, by the computing device, the modified document to the client device.

8. A marketing computing system comprising:
one or more processors;
a memory comprising programmed instructions stored thereon, the one or more processors configured to be capable of executing the stored programmed instructions to:
receive a response to a survey from a client device, wherein the survey is transmitted to the client device and the response is received from the client device via a link;
generate insight data based on marketing data using a machine learning model, wherein the marketing data is generated using a natural language processor by analyzing a prompt based on the response received via the link from the client device; and
provide, to the client device, a graphical user interface comprising the insight data.

9. The system as set forth in claim 8, wherein the survey comprises inquiries related to a market, a transaction, or real estate client preferences.

10. The system as set forth in claim 8, wherein the executable code when executed by the one or more processors further causes the one or more processors to:
store the marketing data and the insight data in a centralized repository;
receive a query from the client device relating to the marketing data or the insight data in the centralized repository; and
transmit a query response to the client device.

11. The system as set forth in claim 10, wherein the executable code when executed by the one or more processors further causes the one or more processors to:
receive a login request from the client device;
authenticate the client device based on login data in the login request;
receive the query related to the marketing data or the insight data; and
generate the query response using the machine learning model by:
tokenizing the query for key components;
matching the key components to a cluster of vectors; and
generating the query response based on the cluster of vectors.

12. The system as set forth in claim 8, wherein the executable code when executed by the one or more processors further causes the one or more processors to:
receive, from the client device, an executive summary request and input relating to the executive summary request;
retrieve related data to the executive summary request or the input from a centralized repository;
transmit a prompt comprising the executive summary request, the input, and the related data to a large language model;
receive the executive summary from the large language model; and
transmit the executive summary to the client device.

13. The system as set forth in claim 8, wherein the executable code when executed by the one or more processors further causes the one or more processors to:
receive, from the client device, a document request;
modify and provide the graphical user interface to the client device, wherein the modified graphical user interface comprises an interactive chat configured to request and receive input from the client device for the document request;
transmit a prompt comprising the document request and the input to a large language model;
receive a document from the large language model, wherein the document meets requirements of the document request and comprises the input from the client device; and
transmit the document to the client device.

14. The system as set forth in claim 13, wherein the executable code when executed by the one or more processors further causes the one or more processors to:
receive edits for the document from the client device;
modify the document using the edits from the client device; and
provide the modified document to the client device.

15. A non-transitory computer readable medium having stored thereon instructions comprising executable code which when executed by one or more processors, causes the one or more processors to:
receive a response to a survey from a client device, wherein the survey is transmitted to the client device and the response is received from the client device via a link;
generate insight data based on marketing data using a machine learning model, wherein the marketing data is generated using a natural language processor by analyzing a prompt based on the response received via the link from the client device; and
provide, to the client device, a graphical user interface comprising the insight data.

16. The medium as set forth in claim 15, wherein the survey comprises inquiries related to a market, a transaction, or real estate client preferences.

17. The medium as set forth in claim 15, wherein the executable code when executed by the one or more processors further causes the one or more processors to:
store the marketing data and the insight data in a centralized repository;
receive a query from the client device relating to the marketing data or the insight data in the centralized repository; and
transmit a query response to the client device.

18. The medium as set forth in claim 17, wherein the executable code when executed by the one or more processors further causes the one or more processors to:
receive a login request from the client device;
authenticate the client device based on login data in the login request;
receive the query related to the marketing data or the insight data; and
generate the query response using the machine learning model by:
tokenizing the query for key components;
matching the key components to a cluster of vectors; and
generating the query response based on the cluster of vectors.

19. The medium as set forth in claim 15, wherein the executable code when executed by the one or more processors further causes the one or more processors to:
receive, from the client device, an executive summary request and input relating to the executive summary request;
retrieve related data to the executive summary request or the input from a centralized repository;
transmit a prompt comprising the executive summary request, the input, and the related data to a large language model;
receive the executive summary from the large language model; and
transmit the executive summary to the client device.

20. The medium as set forth in claim 15, wherein the executable code when executed by the one or more processors further causes the one or more processors to:
receive, from the client device, a document request;
modify and provide the graphical user interface to the client device, wherein the modified graphical user interface comprises an interactive chat configured to request and receive input from the client device for the document request;
transmit a prompt comprising the document request and the input to a large language model;
receive a document from the large language model, wherein the document meets requirements of the document request and comprises the input from the client device; and
transmit the document to the client device.
